(19) United States
(12) Patent Application Publication
(10) Pub. No.: US 2026/0209093 A1
(43) Pub. Date: Jul. 23, 2026

(54) Aerobic Bacterial Generator

(71) Applicant: SLUDGEHAMMER GROUP, LTD., Petoskey, MI (US)

(72) Inventors: Daniel Wickham, Petoskey, MI (US); William Stoddard, Petoskey, MI (US)

(73) Assignee: SLUDGEHAMMER GROUP, LTD., Petoskey, MI (US)

(21) Appl. No.: 19/348,982

(22) Filed: Oct. 3, 2025

Related U.S. Application Data
(60) Provisional application No. 63/748,532, filed on Jan. 23, 2025.

(51) Int. Cl. C02F 3/20; C02F 3/30

(52) U.S. Cl. CPC C02F 3/20; C02F 3/301

(57) ABSTRACT

An aerobic bacterial generator and related methods are disclosed. The generator has a bottom base portion, an aeration ring, and a body column extending from the bottom base portion. The body column has tapered side walls that terminate in a discharge orifice. The tapered body column is wider at its bottom than at its discharge orifice. The aerobic generator generates an improved plume by the upward flow of waste liquid through the generator, thereby creating an improved turnover of oxygen-enriched liquid in a laminar fashion.

### RELATED APPLICATIONS

This application claims the benefit of U.S. Provisional Patent Application No. 63/748,532, filed Jan. 23, 2025, incorporated by reference in its entirety.

### TECHNICAL FIELD

Aerobic bacterial generators (ABG) are devices used to increase circulation of facultative bacteria (FB) through organic waste liquid material in septic tanks or municipal waste facilities. The ABG permits the FB to metabolize mucus based organic material and slow or prevent the effluent from clogging soils. Examples of aerobic bacterial generators are disclosed in U.S. Pat. No. 6,780,318, incorporated herein in its entirety. The disclosed ABG device could be installed in a septic tank, or any other waste containing vessel, and uses air to circulate waste liquid through a chamber to allow cultivation of specific FB that is introduced into the ABG device. The purpose of an ABG is to disperse these FB organisms into the soil disposal systems associated with the septic tank leach fields where they reduce or eliminate mucus based organic material from clogging the soil through the process of fermentation.

U.S. Pat. No. 6,780,318 discloses an ABG as a column shaped device having outer housing of the unit configured as a straight column in which pressurized air passes up and through the device, while also forcing liquid through the column. It has been surprisingly found that certain modifications can be made to the columnar body of the ABG to optimize hydraulic flow characteristics of the liquid passing through the column. These modifications to the configuration of the device can improve the flow characteristics of the ABG and achieve more effective mixing and circulation in waste vessels, such as septic tanks or municipal waste holding tanks, containing such a device. To accelerate the velocity of the liquid through the ABG, larger and more powerful air pumps were employed. Such powerful air pumps are an added capital and operating expense.

There is a need to improve the flow characteristics of ABG in waste management facilities, including private septic tanks and municipal waste treatment facilities, to improve aeration without the need for larger and more expensive air pumps, and decrease the accumulation of mucus based organic material from clogging a waste effluent dispersal soil, such as a septic tank leach field.

### SUMMARY

The hydraulic design of the ABG disclosed in U.S. Pat. No. 6,780,318 allows the rising, air-driven liquid to project with force above the top open rim of the device. Since the unit was placed below the liquid surface this flow caused a plume above the unit that raised the height of the liquid surface relative to the rest of the vessel.

This particular type of flow is similar to what is known as geostrophic flow in the field of oceanography. Warmer water near the tropics expands as it becomes less dense with temperature. Because of the fixed ocean basin, the expansion can only go upwards so the water is elevated relative to the colder water at higher latitudes. Consequently, the water flows “downhill” to the north and south poles driving the major ocean currents, like the Gulf Stream.

The plume caused by the upward flow of an ABG acts in a similar fashion by forcing liquid at the surface in a lateral direction. As liquid encounters the side wall of the tank, it is forced down, creating a large-scale turnover of oxygen enriched liquid from above into the deeper water in a laminar fashion. The ABG can have improved flow characteristics by modifying the walls of the ABG from a column to a vessel having a taper to the shape of the column, thereby accelerating the velocity of the liquid at the point of discharge.

The tapered ABG improves the mixing performance of the unit through a change in the shape of the column. The change involved uses the same dynamic that affects flow out of a hose spigot as the aperture is reduced relative to the diameter of the hose itself. Flow velocity through a tube is a function of volume per unit of time and diameter of the tube. By adding a taper to the shape of a column, the velocity at the point of discharge from the column can be accelerated. In the instance of an ABG column, this acceleration of flow can achieve an extra elevation of the plume directly above the unit. One advantage of the ABG of this disclosure is that by increasing the height of the plume one also increases the geostrophic flow out toward the sides of the tank. This flow is laminar so it can increase the downwelling of oxygenated water while also minimizing turbulence. In one instantiation of the ABG, it was found that moving the height of where the liquid enters the column allows the liquid at the bottom of the tank to remain quiescent. This acts to conserve the function of a septic tank, namely the prevention of the release suspended solids from discharging from the tank into the soil where they could interfere with the percolation into the soil disposal system. Increased mixing without turbulence preserves the solids storage at the bottom of the septic or waste holding tank, while also promoting bacterial digestion in that zone through the introduction of oxygen to the bottom of the septic tank or waste holding tank.

This acceleration is also achieved without the need for larger, more powerful air pumps since the volume of air needed to mix the liquid remains the same, even though velocity increases.

### BRIEF DESCRIPTION OF THE DRAWINGS

FIG. 1A is a schematic representation of an Aerobic Bacterial Generator according to one embodiment of this disclosure.

FIG. 1B is another schematic representation of the Aerobic Bacterial Generator of FIG. 1A.

FIG. 2 is a cut away side view of a waste disposal unit, such as a septic tank, with an ABG according to one embodiment of this disclosure.

### DETAILED DESCRIPTION

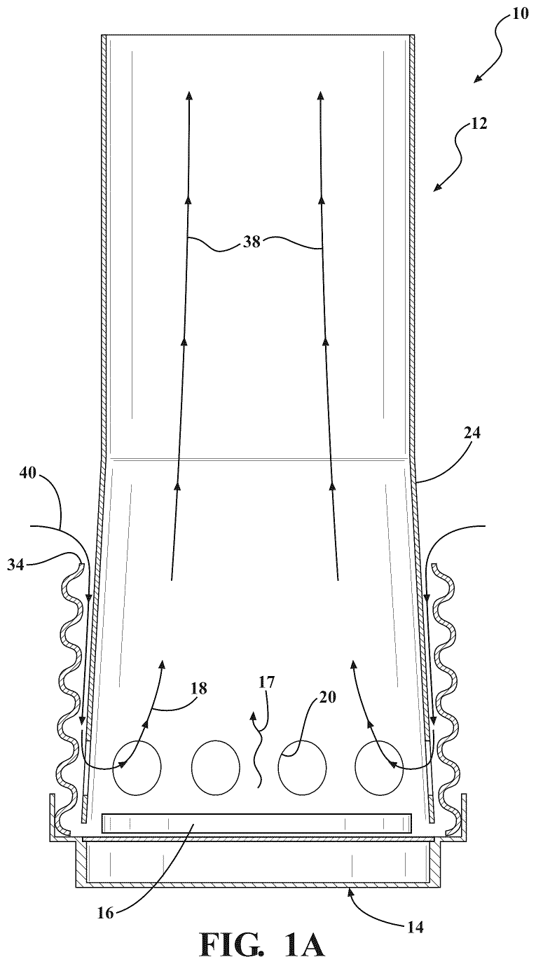

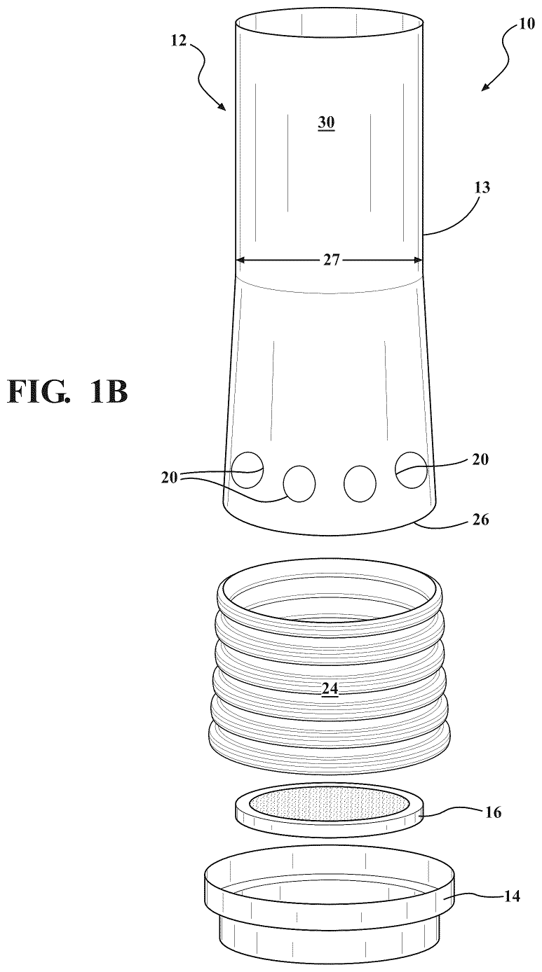

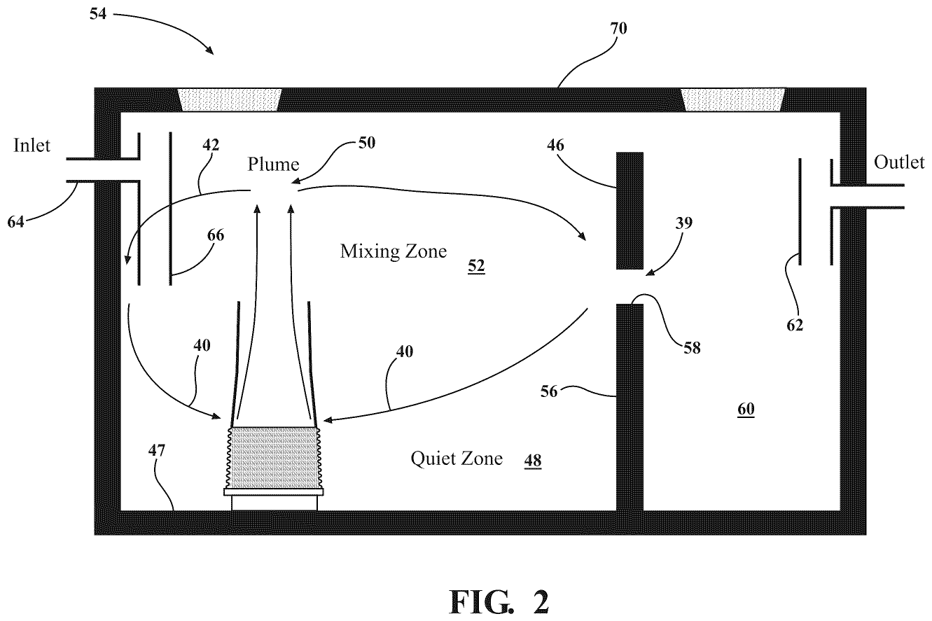

Turning now to the drawings wherein like numbers refer to like structures, FIGS. 1A, 1B and FIG. 2. depict one ABG 10 according to one embodiment of the disclosure. The ABG includes a vertical column portion 12 that is closed with a fixture 14 at the base or bottom 26. The column has sidewall 13 and is hollow, with an interior 30 with an open end 32. Inside the column at its base is a fine-bubble air diffuser 16 that is supplied with pressurized air from an outside source. A sheet of cuspated plastic 22 is wrapped around the base forcing liquid to enter the column from a height 34 above the bottom. The airstream 17 pushes liquid in the column upward 18 as it draws it into the column through perforations 20. As the liquid inside the column rises it encounters point 24 where diameter 27 of the column begins to decrease relative to the base, causing an accelerated flow 38.

FIG. 2 shows the ABG in a septic tank 54. Untreated wastewater is delivered from a house 64 through a conduit 66 that extends through an opening or aperture in the tank. The accelerated flow 38 elevates the liquid above the column creating plume 50 and increases its height relative to liquid further from the column. As the ABG is operated, gravity causes a geostrophic flow 42 away from the column and towards the sidewalls 56 of the tank. When the flow encounters the sides of the tank it is forced in a downward direction 40. As the flow continues toward the bottom 47 it encounters the quiescent or quiet zone 48 and moves in a laminar manner to the column where it is again drawn into the column.

In this fashion, the upper zone or aerobic mixing zone 52 of the tank is highly turbulent. Organic solids can stay suspended for a time in the aerobic mixing zone with oxygenation promoting bacterial digestion of the solids. At the same time solids can sink below the mixed zone into the quiescent zone to be retained in the tank. In operation, the ABG a creates a culture of facultative bacteria (FB) that can shift from aerobic digestion in the upper aerobic zone to fermentation in the lower anoxic zone. This activity acts to liquify the solids by hydrolysis in the lower quiescent zone so that the soluble byproducts can diffuse into the upper aerobic zone for aerobic digestion without turbulent mixing in a way that the zonation of the tank is preserved. Treated water is exited from the tank through an orifice or outlet aperture 58 and directed to a treated section 60 of the tank where it is exited through an outlet 62 to a leach field.

Those skilled in the art will understand that many variations and modifications are possible without departing from the scope of the invention as set forth in the claims.

We claim:

1. A method to operate an aerobic bacterial generator to improve waste flow management to a leach field, comprising placing a vertical tapered hollow cylindrical column having an opening at an upper end opposite a base inside a waste containing vessel such as a septic tank having a top, a bottom and walls, and forcing air through the column to aerate the waste.

2. The method of claim 1, wherein the column is supplied with pressurized air by a diffuser at the base.

3. The method of claim 2, wherein the rising air from the diffuser creates an upward current of liquid.

4. The method of claim 3, wherein new liquid enters the column through perforations at a base of the column as the liquid inside the column rises due to upward current of liquid.

5. The method of claim 4, wherein a plastic baffle sheet forces the liquid to enter the base from a point above a bottom of a septic tank, thereby creating a non-mixed quiescent or quiet zone at the bottom of the tank.

6. The method of claim 5, wherein the column is reduced in diameter as it approaches the opening at the upper end forcing the liquid stream to accelerate.

7. The method of claim 6, wherein the accelerated flow at the outlet creates a plume of liquid above the device that is higher than can be achieved without use of a flow constriction.

8. The method of claim 7, wherein an increase in the height of the liquid forces flow to the sidewalls of the tank by gravity.

9. The method of claim 8, where the lateral flow encounters the tank sidewalls and is forced in a downward fashion.

10. The method of claim 9, wherein the downward flow brings oxygen into a quiet zone of the tank in a laminar fashion that reduces turbulent mixing in the quiet zone.

11. The method of claim 10, wherein solids are retained in the quiet zone for liquefaction through fermentative hydrolysis.

12. The method of claim 11, wherein the soluble products move by diffusion into the mixing zone for aerobic digestion.

13. An aerobic bacterial generator, comprising: a bottom base portion; an aeration ring in said bottom base portion; a body column extending from said bottom base portion, said body column having tapered side walls extending from the bottom portion a distance and terminating in a discharge orifice, said body column having a tapered configuration, being wider at its bottom than at its discharge orifice; said side walls at said bottom portion being equipped with at least one inlet orifice; said bottom portion at said sidewall inlet orifice being covered by a cuspated material.
